(19) United States
(12) Patent Application Publication
(10) Pub. No.: US 2026/0269907 A1
(43) Pub. Date: Sep. 10, 2026

(54) METHOD AND APPARATUS FOR ARTIFICIAL INTELLIGENCE-BASED CHANNEL STATE INFORMATION PREDICTION IN MOBILE COMMUNICATIONS

(71) Applicant: MEDIATEK INC., Hsinchu City (TW)

(72) Inventor: Yu-Ching HUANG, Hsinchu City (TW)

(73) Assignee: MEDIATEK INC., Hsinchu City (TW)

(21) Appl. No.: 19/473,209

(22) PCT Filed: Jul. 3, 2024
(86) PCT No.: PCT/CN2024/103279

§ 371 Date: Oct. 7, 2025

Related U.S. Application Data
(60) Provisional application No. 63/519,288, filed on Aug. 14, 2023.

(51) Int. Cl. H04B 7/06; H04B 17/373; H04W 8/22

(52) U.S. Cl. CPC H04B 7/0626; H04B 17/373; H04W 8/22

(57) ABSTRACT

Various solutions for artificial intelligence (AI)-based channel state information (CSI) prediction with respect to user equipment and network apparatus in mobile communications are described. An apparatus may receive a channel state information-reference signal (CSI-RS) from a network node. The apparatus may perform a CSI prediction according to a CSI prediction model and the CSI-RS. The apparatus may perform a model monitoring on the CSI prediction model to determine whether to adjust the CSI prediction model.

### CROSS REFERENCE TO RELATED PATENT APPLICATION(S)

The present disclosure is part of a non-provisional application claiming the priority benefit of U.S. Patent Application No. 63/519,288, filed 14 Aug. 2023, the content of which herein being incorporated by reference in its entirety.

### TECHNICAL FIELD

The present disclosure is generally related to mobile communications and, more particularly, to artificial intelligence (AI)-based channel state information (CSI) prediction with respect to user equipment (UE) and network apparatus in mobile communications.

### BACKGROUND

Unless otherwise indicated herein, approaches described in this section are not prior art to the claims listed below and are not admitted as prior art by inclusion in this section.

In 5th-generation (5G) New Radio (NR) mobile communications, artificial intelligence (AI)/machine learning (ML) schemes are introduced to facilitate positioning for an apparatus. Model inference is an important process for AI/ML schemes.

In the multi-input multi-output (MIMO) system, unpredictable processing and channel state information (CSI) feedback delays may degrade the spectral efficiency, especially in high mobility scenarios. To mitigate such degradation caused by channel aging, future channel prediction is proposed, in which the overall goal is to predict what could be the actual channel state at the time it is being used, based on available observed channels.

Accordingly, how to apply the model inference to channel state information (CSI) prediction to enhance channel estimation becomes an important issue in the newly developed wireless communication network. Therefore, there is a need to provide proper schemes to monitor and improve model performance.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to artificial intelligence (AI)-based channel state information (CSI) prediction with respect to user equipment and network apparatus in mobile communications. It is believed that the above-described issue would be avoided or otherwise alleviated by implementing one or more of the proposed schemes described herein.

In one aspect, a method may involve an apparatus receiving a channel state information-reference signal (CSI-RS) from a network node. The method may also involve the apparatus performing a CSI prediction according to a CSI prediction model and the CSI-RS. The method may further involve the apparatus performing a model monitoring on the CSI prediction model to determine whether to adjust the CSI prediction model.

In another aspect, an apparatus may involve a transceiver which, during operation, wirelessly communicates with at least one network node. The apparatus may also involve a processor communicatively coupled to the transceiver such that, during operation, the processor may receive, via the transceiver, a CSI-RS from the network node. The processor may also perform a CSI prediction according to a CSI prediction model and the CSI-RS. The processor may further perform a model monitoring on the CSI prediction model to determine whether to adjust the CSI prediction model.

It is noteworthy that, although description provided herein may be in the context of certain radio access technologies, networks and network topologies such as 5^{th} Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), 6th Generation (6G), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario for a CSI prediction procedure in accordance with implementations of the present disclosure.

FIG. 3 is a diagram depicting an example scenario for a model monitoring process under the second proposed scheme in accordance with implementations of the present disclosure.

FIG. 4 is a diagram depicting an example scenario for a model monitoring process under the third proposed scheme in accordance with implementations of the present disclosure.

FIG. 5 is a diagram depicting an example scenario for a model monitoring procedure in accordance with implementations of the present disclosure

FIG. 6 is a block diagram of an example communication system in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to artificial intelligence (AI)-based channel state information (CSI) prediction with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

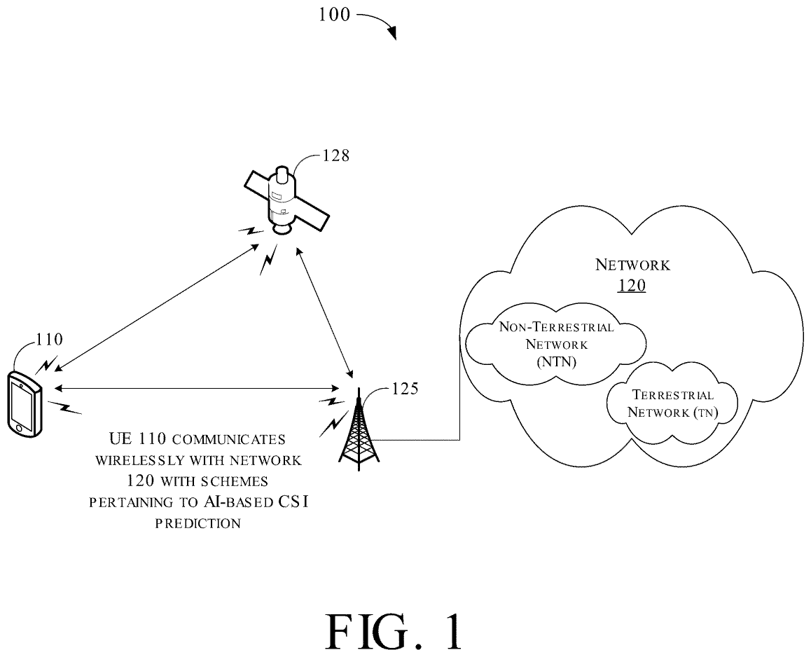

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including an NTN and a TN) via a terrestrial network node 125 (e.g., an evolved Node-B (eNB), a Next Generation Node-B (gNB), or a transmission/reception point (TRP)) and/or a non-terrestrial network node 128 (e.g., a satellite). For example, the terrestrial network node 125 and/or the non-terrestrial network node 128 may form a non-terrestrial network (NTN) serving cell for wireless communication with the UE 110. In some implementations, the UE 110 may be an IoT device such as an NB-IoT UE or an enhanced machine-type communication (eMTC) UE (e.g., a bandwidth reduced low complexity (BL) UE or a coverage enhancement (CE) UE). In such communication environment, the UE 110, the network 120, the terrestrial network node 125, and the non-terrestrial network node 128 may implement various schemes pertaining to AI-based CSI prediction in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

According to the implementations of the present disclosure, a UE (e.g., the UE 110) may receive a channel state information-reference signal (CSI-RS) from a network node (e.g., the terrestrial network node 125). Then, the UE may perform a CSI prediction according to a CSI prediction model and the CSI-RS. In addition, the UE may perform a model monitoring on the CSI prediction model to determine whether to adjust the CSI prediction model. In the present disclosure, the CSI prediction model may be implemented by an AI model, a machine learning (ML) model or any other algorithm models. Different CSI prediction model may respectively correspond to different functions.

Under a first proposed scheme for the CSI prediction procedure (or model inference procedure) in accordance with the present disclosure, before the UE receives the CSI-RS from the network node, the UE may transmit (or report) its UE capability to the network node. Then, the UE and the network node may align the CSI prediction model identification (ID) (or CSI prediction functionality identification) with each other. For example, the UE may communicate with the network node which CSI prediction model is supported. That is, the network node may know which CSI prediction model (or models) the UE supports according to the aligned CSI prediction model ID (or IDs). The network node may trigger the AI-based or ML-based CSI prediction process, and configure a suitable CSI prediction model ID from the CSI prediction model IDs which the UE supports to the UE. Then, the UE may perform the CSI prediction according to the CSI prediction model with the configured CSI prediction model ID. If the network node does not find any suitable CSI prediction model from the CSI prediction models which the UE supports, the network node may not configure the CSI prediction model ID to the UE, i.e., the network node may not trigger the AI-based or ML-based CSI prediction process.

In some implementations, the UE capability may comprise at least one of a CSI prediction capability, a model fine-tuning capability, a non-AI-based CSI prediction capability, and any other relevant information used for the model monitoring. The CSI prediction capability may be used to indicate whether the UE supports AI-based CSI prediction. The model fine-tuning capability may be used to indicate whether the UE supports the fine-tuning for the CSI prediction model. The non-AI-based CSI prediction capability may be used to indicate whether the UE supports non-AI-based CSI prediction (e.g., the UE is capable of performing model fallback process). The CSI prediction capability, the model fine-tuning capability, and the non-AI-based CSI prediction capability may be respectively indicated by one bit. For example, an extra bit may be added to the exiting N₄ value to indicate whether the UE supports the AI-based CSI prediction or the non-AI-based CSI prediction. The N₄ value is used to represent the number of Doppler domain (DD) units and indicate how far the UE can predict.

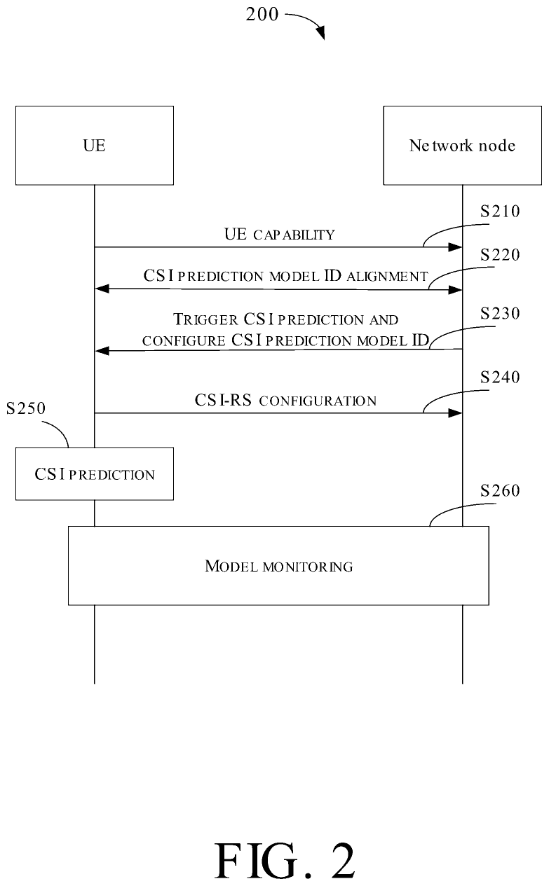

FIG. 2 illustrates an example scenario 200 for a CSI prediction procedure under the first proposed scheme in accordance with implementations of the present disclosure. Scenario 200 involves a UE and a network node (e.g., a (macro/micro) base station) of a wireless network (e.g., an LTE network, a 5G/NR network, an IoT network or a 6G network). Referring to FIG. 2, in step S210, the UE may transmit its UE capability to the network node.

In step S220, the UE and the network node may align the CSI prediction model identification (ID) (or CSI prediction functionality identification). That is, the network node may know which CSI prediction model (or models) the UE supports according to the aligned CSI prediction model ID (or IDs).

In step S230, the network node may trigger the AI-based or ML-based CSI prediction process, and configure a suitable CSI prediction model ID from the CSI prediction model IDs which the UE supports to the UE.

In step S240, the UE may receive the CSI-RS configuration from the network node. The CSI-RS configuration may configure the CSI-RS resources (e.g., the information of the CSI-RS).

In step S250, the UE may perform the CSI prediction according to the CSI prediction model with the CSI prediction model ID configured by the network node and according to the CSI-RS in the CSI-RS configuration. Specifically, the UE may perform measurement for the CSI-RS. Then, the UE may input the measurement results (e.g., channel information of current channel) collected in a period of time (e.g., an observation window) into the CSI prediction model to generate the prediction results (e.g., predicted channel information of future channel). Then, the UE may transmit the CSI-RS report to the network node according to the prediction results. Accordingly, the network may be able to acquire more accurate channel information based on the prediction results.

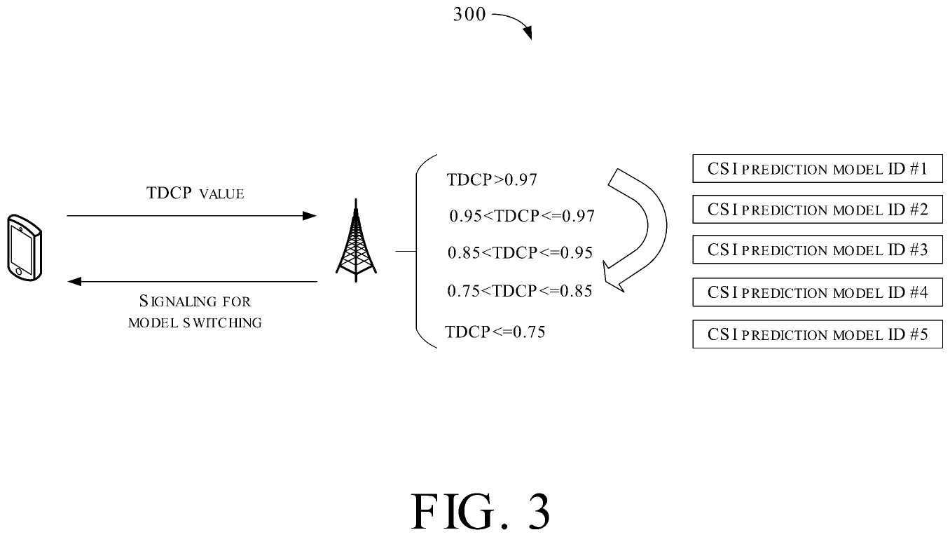

In step S260, the UE may perform a model monitoring on the CSI prediction model to determine whether to adjust the CSI prediction model. Details for the model monitoring will be discussed below by referring to FIGS. 3-6.

Under a second proposed scheme for the CSI prediction procedure in accordance with the present disclosure, the UE may trigger the CSI prediction automatically without receiving a CSI prediction model ID from the network node. That is, in the second proposed scheme, the UE may not perform steps S210-S230 of FIG. 2. The UE can independently determine when to trigger the AI-based or ML-based CSI prediction process.

In some circumstances, the CSI prediction model may not match or suitable for the current environment and scenario. Therefore, the UE may need to perform a model monitoring on the CSI prediction model to determine whether to adjust the CSI prediction model. The UE may determine to perform a model switching process, a model updating process, a model fallback process, or a model deactivation process according to different conditions to adjust the CSI prediction model.

Under a first proposed scheme for the model monitoring (i.e., intermediate-key performance indicator (KPI)-based model monitoring) in accordance with the present disclosure, the UE may determine a difference between the intermediate-KPI values from a previous time point and a current time point. Then, the UE may determine whether to switch the CSI prediction model according the difference. For example, the UE may determine whether a difference between a first normalized mean square error (NMSE) value at a current monitoring time point and a second NMSE value at a previous monitoring time point is larger than a threshold. The UE may compare the difference with a threshold to determine whether to switch the CSI prediction model. For example, when the difference is larger than the threshold (i.e., |NMSEₚᵣₑᵥᵢₒᵤₛ−NMSE_{current}|>threshold), the UE may determine to switch the CSI prediction model, i.e., a model switching process needs to be triggered. When the difference is not larger than the threshold (i.e., |NMSEₚᵣₑᵥᵢₒᵤₛ−NMSE_{current}|≤threshold), the UE may determine that the current CSI prediction model can be used continuously.

Under a second proposed scheme for the model monitoring (i.e., the time-domain-channel-properties (TDCP)-based model monitoring) in accordance with the present disclosure, the UE may calculate a TDCP value. Then, the UE may determine whether to switch the CSI prediction model according to the TDCP value. Specifically, the UE may transmit the TDCP value to the network node. The network node may determine whether to switch the CSI prediction model according to the TDCP value from the UE. Different ranges of TDCP values may correspond to different speeds of the UE. In addition, different speeds may correspond to different CSI prediction models. Therefore, the network node may drive the current speed of the UE according to the TDCP value from the UE to determine whether to switch the CSI prediction model which being used by the UE. In an example, when the network node determines to switch the CSI prediction model, the network node may select a suitable CSI prediction model from a plurality of candidate suitable CSI prediction models (e.g., the CSI prediction models with the aligned CSI prediction model IDs between the UE and the network node) according to the current speed of the UE. Then, the network node may transmit a signaling to the UE to trigger the model switching process, i.e., the UE may switch to the suitable CSI prediction model selected by the network node. In another example, when the network node determines to switch the CSI prediction model, but the network node cannot find a suitable CSI prediction model according to the current speed of the UE, a model updating process, a model fallback process, or a model deactivation process may be performed by the UE according to different conditions to adjust the CSI prediction model.

FIG. 3 illustrates an example scenario 300 for a model monitoring process under the second proposed scheme in accordance with implementations of the present disclosure. Scenario 300 involves a UE and a network node (e.g., a (macro/micro) base station) of a wireless network (e.g., an LTE network, a 5G/NR network, an IoT network or a 6G network). Referring to FIG. 3, the UE may calculate a TDCP value, and transmit the TDCP value to the network node. The network node may determine the TDCP value is in which TDCP range (e.g., TDCP>0.97, 0.95<TDCP≤0.97, 0.85<TDCP≤0.95, 0.75<TDCP≤0.85, or TDCP≤0.75) to derive the speed of the UE. Different speeds may correspond to different CSI prediction models (e.g., the CSI prediction model with the CSI prediction model (or functionality) ID #1, the CSI prediction model with the CSI prediction model ID #2, the CSI prediction model with the CSI prediction model ID #3, the CSI prediction model with the CSI prediction model ID #4, and the CSI prediction model with the CSI prediction model ID #5). Therefore, the network node may determine whether to switch the CSI prediction model which is used by the UE currently according to the current speed of the UE. When the network node determines to switch the CSI prediction model, the network node may select a suitable CSI prediction model according to the current speed of the UE. Then, the network node may transmit a signaling to the UE to trigger the model switching process, i.e., the UE may switch to the suitable CSI prediction model selected by the network node.

Under a third proposed scheme for the model monitoring (i.e., the global navigation satellite system (GNSS)-based model monitoring) in accordance with the present disclosure, the UE may obtain a GNSS information. Then, the UE may determine whether to switch the CSI prediction model according to a speed associated with the GNSS information. Specifically, the UE may receive the GNSS information from a satellite. Then, the UE may estimate its speed according the GNSS information, and transmit the estimated speed to the network node. The network node may determine whether to switch the CSI prediction model according to the estimated speed from the UE. Different ranges of speeds of the UE may correspond to different CSI prediction models. Therefore, the network node may determine whether to switch the CSI prediction model of the UE according to the estimated speed from the UE. In an example, when the network node determines to switch the CSI prediction model, the network node may select a suitable CSI prediction model from a plurality of candidate suitable CSI prediction models (e.g., the CSI prediction models with the aligned CSI prediction model IDs between the UE and the network node) according to the estimated speed of the UE. Then, the network node may transmit a signaling to the UE to trigger the model switching process, i.e., the UE may switch to the suitable CSI prediction model selected by the network node. In another example, when the network node determines to switch the CSI prediction model, but the network node cannot find a suitable CSI prediction model according to the estimated speed of the UE, a model updating process, a model fallback process, or a model deactivation process may be performed by the UE according to different conditions to adjust the CSI prediction model.

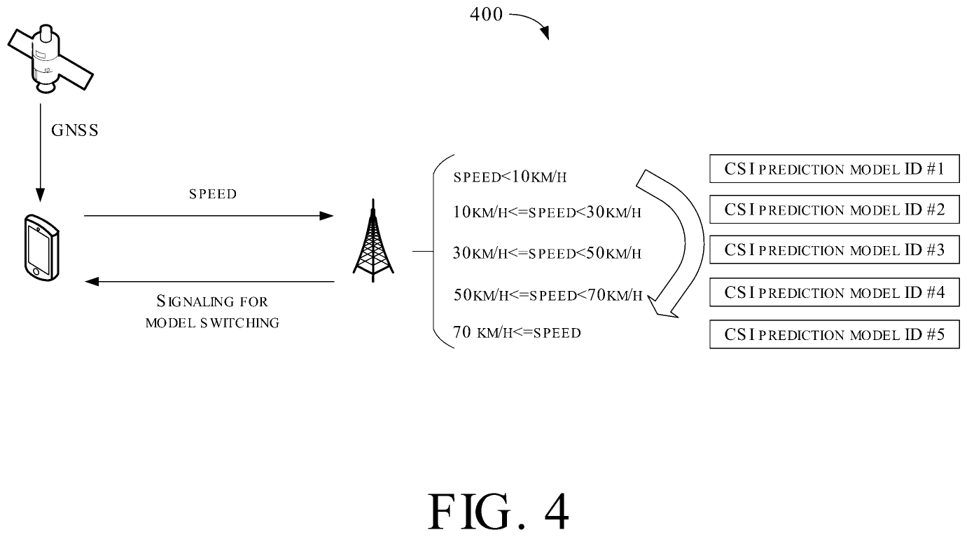

FIG. 4 illustrates an example scenario 400 for a model monitoring process under the third proposed scheme in accordance with implementations of the present disclosure. Scenario 400 involves a UE and a network node (e.g., a (macro/micro) base station) of a wireless network (e.g., an LTE network, a 5G/NR network, an IoT network or a 6G network). Referring to FIG. 4, the UE may receive the GNSS information from a satellite. Then, the UE may estimate its speed according the GNSS information, and transmit the estimated speed to the network node. The network node may determine the estimated speed is in which speed range (e.g., speed<10 km/hour (h), 10 km/h≤speed<30 km/h, 30 km/h≤speed<50 km/h, 50 km/h≤speed<70 km/h, or 70 km/h≤speed) to derive the speed of the UE. Different speed ranges may correspond to different CSI prediction models (e.g., the CSI prediction model with the CSI prediction model (or functionality) ID #1, the CSI prediction model with the CSI prediction model ID #2, the CSI prediction model with the CSI prediction model ID #3, the CSI prediction model with the CSI prediction model ID #4, and the CSI prediction model with the CSI prediction model ID #5). Therefore, the network node may determine whether to switch the CSI prediction model which being used by the UE according to the estimated speed of the UE. When the network node determines to switch the CSI prediction model, the network node may select a suitable CSI prediction model according to the estimated speed of the UE. Then, the network node may transmit a signaling to the UE to trigger the model switching process, i.e., the UE may switch to the suitable CSI prediction model selected by the network node.

According to the implementations of the present disclosure, the UE may perform a model fine-tuning operation for the CSI prediction model in an event that a model fine-tuning condition is met. The model fine-tuning may be that the UE supports the fine-tuning process and the UE has sufficient resources to collect data for fine-tuning. If the model fine-tuning condition is met, when the network node determines to perform the fine-tuning process, the network node may transmit a signaling to the UE to trigger the UE to perform the model fine-tuning operation. Specifically, the network node may transmit the fine-tuning indication/configuration to the UE. Then, the UE may perform the model fine-tuning operation according to the fine-tuning data to update or re-train the current CSI prediction model, i.e., model updating process. In an example, the fine-tuning process may be performed on a UE-side over-the-top (OTT) server. If the model fine-tuning condition is not met, the network node may determine to perform another process, e.g., a fallback process.

According to the implementations of the present disclosure, the UE may perform a fallback operation to deactivate the CSI prediction model or reduce a prediction length of the CSI prediction model in an event that a fallback condition is met. In an example, the fallback condition may be that the UE supports a non-AI CSI prediction. In another example, the fallback condition may be that the UE supports to reduce the prediction length of the CSI prediction model for a high-speed scenario. That is, when the UE is changed from a low-speed scenario to a high-speed scenario, the UE can reduce the prediction length of the CSI prediction model. For example, when the speed of the UE is increased by two times, in the fallback process, the UE can decrease the prediction length of the CSI prediction model by two times.

When the network node knows that the fallback condition is met (e.g., the UE can support non-AI CSI prediction or the UE can support to reduce the prediction length of the CSI prediction model), and the network node determines to perform a fallback process, the network node may transmit a signaling to the UE to the UE to trigger the UE to perform the fallback process. That is, the UE may deactivate the current prediction model (i.e., AI-based or ML-based CSI prediction model), and fall back to the non-AI CSI prediction, or the UE may reduce the prediction length of the current CSI prediction model.

In another example, even if the network node does not know whether the fallback condition is met, when the network node determines to perform a fallback process, the network node may also transmit a signaling to the UE to trigger the UE to perform the fallback process. Then, the UE may decide whether to perform the fallback process according to its capability. If the UE supports the fallback condition (i.e., the fallback condition is met), the UE may perform the fallback process. If the UE does not support the fallback condition (i.e., the fallback condition is not met), the UE may transmit a response to the network node to deactivate the CSI prediction model, i.e., the AI-based or ML-based CSI prediction will be terminated.

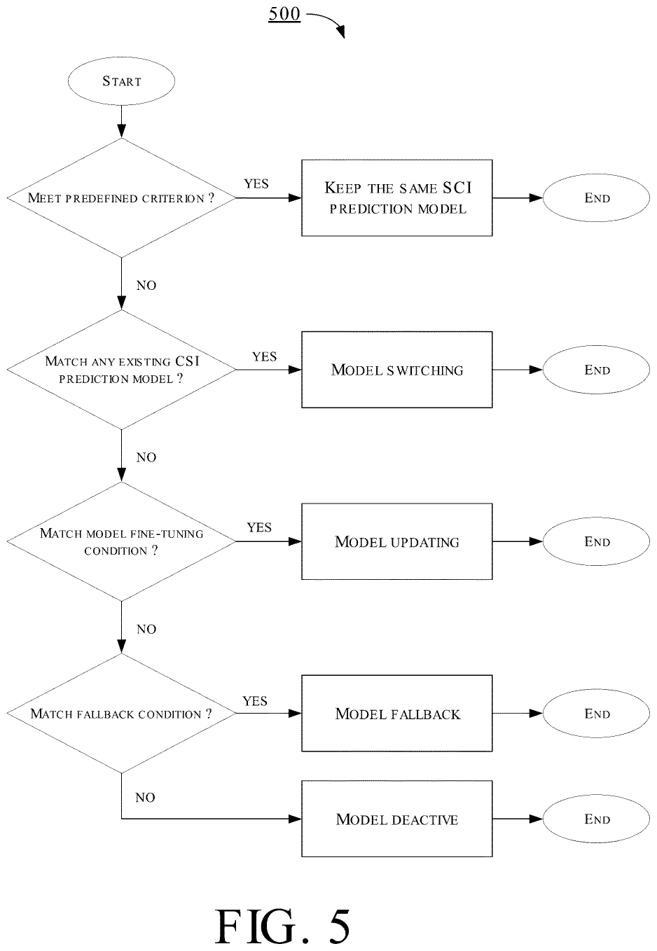

FIG. 5 illustrates an example scenario 500 for a model monitoring procedure in accordance with implementations of the present disclosure. Scenario 500 involves a UE and a network node (e.g., a (macro/micro) base station) of a wireless network (e.g., an LTE network, a 5G/NR network, an IoT network or a 6G network). Referring to FIG. 5, the UE may determine whether a predefined criterion is met. Specifically, the UE may determine a difference between the intermediate-KPI values (e.g., NMSE values) from a previous time point and a current time point. Then, the UE may determine whether to switch the CSI prediction model according the difference. When the predefined criterion is met (e.g., |NMSEₚᵣₑᵥᵢₒᵤₛ−NMSE_{current}|≤threshold), the UE may determine that the current CSI prediction model can be used continuously, i.e., the UE may keep the same CSI prediction mode for inference.

When the predefined criterion is not met (e.g., |NMSEₚᵣₑᵥᵢₒᵤₛ−NMSE_{current}|>threshold), the UE may determine to switch the CSI prediction model, i.e., a model switching process needs to be triggered. The network node may determine whether there is a suitable CSI prediction mode for model switching according to the assistance information (e.g., TDCP value or speed associated with the GNSS information) from the UE. When the network node determines that there is a suitable CSI prediction mode for model switching, the network node may transmit a signaling to the UE to trigger the model switching process, i.e., the UE may switch to the suitable CSI prediction model. When the network node determines that there is no suitable CSI prediction mode for model switching, the network node may determine whether the model fine-tuning condition is met.

When the model fine-tuning condition is met (e.g., the UE supports the fine-tuning process and the UE has sufficient resources to collect data for fine-tuning), the network node may transmit a signaling to the UE to trigger the UE to perform the model fine-tuning operation. When the model fine-tuning condition is not met, the network node may determine whether the fallback condition is met.

When the fallback condition is met (e.g., the UE can support non-AI CSI prediction or the UE can support to reduce the prediction length of the CSI prediction model), the network node may transmit a signaling to the UE to trigger the UE to perform the fallback process. When the fallback condition is not met, the UE may transmit a response to the network node to deactivate the CSI prediction model, i.e., the AI-based or ML-based CSI prediction will be terminated.

### Illustrative Implementations

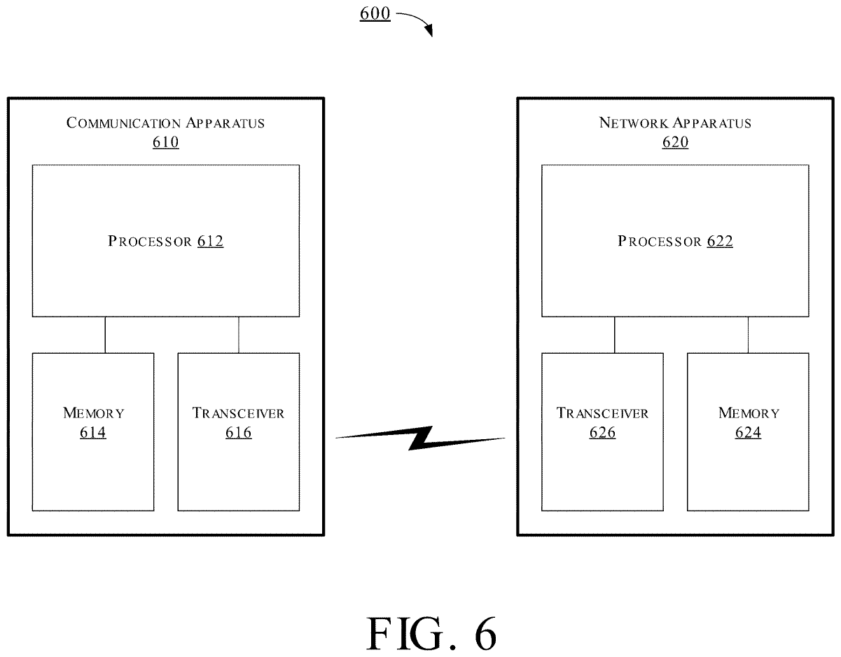

FIG. 6 illustrates an example communication system 600 having an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to AI-based CSI prediction, including scenarios/schemes described above as well as process 700 described below.

Communication apparatus 610 may be a part of an electronic apparatus, which may be a UE such as a portable or mobile apparatus, a wearable apparatus, a wireless communication apparatus or a computing apparatus. For instance, communication apparatus 610 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 610 may also be a part of a machine type apparatus, which may be an IoT, NB-IoT, eMTC, IIoT UE such as an immobile or a stationary apparatus, a home apparatus, a roadside unit (RSU), a wire communication apparatus or a computing apparatus. For instance, communication apparatus 610 may be implemented in a smart thermostat, a smart fridge, a smart door lock, a wireless speaker or a home control center. Alternatively, communication apparatus 610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 610 may include at least some of those components shown in FIG. 6 such as a processor 612, for example. Communication apparatus 610 may further include one or more other components not pertinent to the proposed schemes of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of an electronic apparatus, which may be a network node such as a satellite, a BS, a small cell, a router or a gateway of an IoT network. For instance, network apparatus 620 may be implemented in a satellite or an eNB/gNB/TRP in a 4G/5G/B5G/6G, NR, IoT, NB-IoT or IIoT network. Alternatively, network apparatus 620 may be implemented in the form of one or more IC chips such as, for example and without limitation, one or more single-core processors, one or more multi-core processors, or one or more RISC or CISC processors. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks, including PHR for MTRP operation, in a device (e.g., as represented by communication apparatus 610) and a network node (e.g., as represented by network apparatus 620) in accordance with various implementations of the present disclosure.

In some implementations, communication apparatus 610 may also include a transceiver 616 coupled to processor 612 and capable of wirelessly transmitting and receiving data. In some implementations, transceiver 616 may be capable of wirelessly communicating with different types of UEs and/or wireless networks of different radio access technologies (RATs). In some implementations, transceiver 616 may be equipped with a plurality of antenna ports (not shown) such as, for example, four antenna ports. That is, transceiver 616 may be equipped with multiple transmit antennas and multiple receive antennas for multiple-input multiple-output (MIMO) wireless communications. In some implementations, network apparatus 620 may also include a transceiver 626 coupled to processor 622. Transceiver 626 may include a transceiver capable of wirelessly transmitting and receiving data. In some implementations, transceiver 626 may be capable of wirelessly communicating with different types of UEs of different RATs. In some implementations, transceiver 626 may be equipped with a plurality of antenna ports (not shown) such as, for example, four antenna ports. That is, transceiver 626 may be equipped with multiple transmit antennas and multiple receive antennas for MIMO wireless communications.

In some implementations, communication apparatus 610 may further include a memory 614 coupled to processor 612 and capable of being accessed by processor 612 and storing data therein. In some implementations, network apparatus 620 may further include a memory 624 coupled to processor 622 and capable of being accessed by processor 622 and storing data therein. Each of memory 614 and memory 624 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 614 and memory 624 may include a type of read-only memory (ROM) such as mask ROM, programmable ROM (PROM), erasable programmable ROM (EPROM) and/or electrically erasable programmable ROM (EEPROM). Alternatively, or additionally, each of memory 614 and memory 624 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 610 and network apparatus 620 may be a communication entity capable of communicating with each other using various proposed schemes in accordance with the present disclosure. For illustrative purposes and without limitation, descriptions of capabilities of communication apparatus 610, as a UE, and network apparatus 620, as a network node (e.g., TRP), are provided below with process 700.

### Illustrative Processes

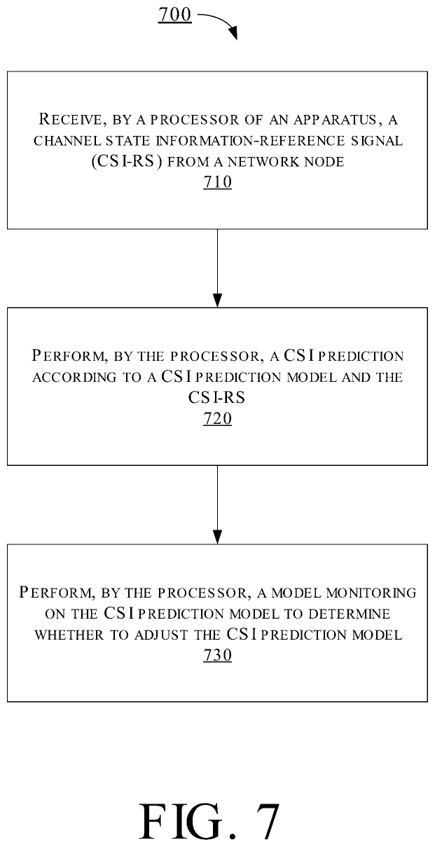

FIG. 7 illustrates an example process 700 under schemes in accordance with an implementation of the present disclosure. Process 700 may represent an aspect of implementing various proposed designs, concepts, schemes, systems and methods described above, whether partially or entirely, including those described above. More specifically, process 700 may represent an aspect of the proposed concepts and schemes pertaining to AI-based CSI prediction in mobile communications. Process 700 may include one or more operations, actions, or functions as illustrated by one or more of blocks 710, 720 and 730. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively in a different order. Furthermore, one or more of the blocks/sub-blocks of process 700 may be executed iteratively. Process 700 may be implemented by or in communication apparatus 610 as well as any variations thereof. Solely for illustrative purposes and without limiting the scope, process 700 is described below in the context of communication apparatus 610 as a UE and network apparatus 620 as a network node (e.g., TRP). Process 700 may begin at block 710.

At block 710, process 700 may involve processor 612 of communication apparatus 610, implemented in or as a UE, receiving a CSI-RS from a network node. Process 700 may proceed from block 710 to block 720.

At block 720, process 700 may involve processor 612 performing a CSI prediction according to a CSI prediction model and the CSI-RS. Process 700 may proceed from block 720 to block 730.

At block 730, process 700 may involve processor 612 performing a model monitoring on the CSI prediction model to determine whether to adjust the CSI prediction model.

In some implementations, process 700 may involve processor 612 transmitting a UE capability to the network node. Process 700 may also involve processor 612 receiving a CSI prediction model ID of the CSI prediction model from the network node.

In some implementations, the UE capability may comprise at least one of a CSI prediction capability, a model fine-tuning capability, and a non-AI-based CSI prediction capability.

In some implementations, the CSI prediction capability, the model fine-tuning capability, and the non-AI-based CSI prediction capability may be respectively indicated by one bit.

In some implementations, process 700 may involve processor 612 triggering the CSI prediction without receiving a CSI prediction model ID from the network node.

In some implementations, process 700 may involve processor 612 determining whether a difference between a first NMSE value at a current monitoring time point and a second NMSE value at a previous monitoring time point is larger than a threshold. Process 700 may also involve processor 612 determining to switch the CSI prediction model in an event that the difference is larger than the threshold.

In some implementations, process 700 may involve processor 612 calculating a TDCP value. Process 700 may also involve processor 612 determining whether to switch the CSI prediction model according to the TDCP value.

In some implementations, process 700 may involve processor 612 obtaining GNSS information. Process 700 may also involve processor 612 determining whether to switch the CSI prediction model according to a speed associated with the GNSS information.

In some implementations, process 700 may involve processor 612 performing a model fine-tuning operation for the CSI prediction model in an event that a model fine-tuning condition is met.

In some implementations, process 700 may involve processor 612 performing a fallback operation to deactivate the CSI prediction model or reduce a prediction length of the CSI prediction model in an event that a fallback condition is met.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a channel state information-reference signal (CSI-RS) from a network node;
performing, by the processor, a CSI prediction according to a CSI prediction model and the CSI-RS; and
performing, by the processor, a model monitoring on the CSI prediction model to determine whether to adjust the CSI prediction model.

2. The method of claim 1, further comprising:
transmitting, by the processor, a user equipment (UE) capability to the network node; and
receiving, by the processor, a CSI prediction model identification (ID) of the CSI prediction model from the network node.

3. The method of claim 2, wherein the UE capability comprises at least one of a CSI prediction capability, a model fine-tuning capability, and a non-AI-based CSI prediction capability.

4. The method of claim 3, wherein the CSI prediction capability, the model fine-tuning capability, and the non-AI-based CSI prediction capability are respectively indicated by one bit.

5. The method of claim 1, further comprising:
triggering, by the processor, the CSI prediction without receiving a CSI prediction model ID from the network node.

6. The method of claim 1, wherein the performing of the model monitoring comprises:
determining, by the processor, whether a difference between a first normalized mean square error (NMSE) value at a current monitoring time point and a second NMSE value at a previous monitoring time point is larger than a threshold; and
determining, by the processor, to switch the CSI prediction model in an event that the difference is larger than the threshold.

7. The method of claim 1, wherein the performing of the model monitoring comprises:
calculating, by the processor, a time-domain-channel-properties (TDCP) value; and
determining, by the processor, whether to switch the CSI prediction model according to the TDCP value.

8. The method of claim 1, wherein the performing of the model monitoring comprises:
obtaining, by the processor, a global navigation satellite system (GNSS) information; and
determining, by the processor, whether to switch the CSI prediction model according to a speed associated with the GNSS information.

9. The method of claim 1, further comprising:
performing, by the processor, a model fine-tuning operation for the CSI prediction model in an event that a model fine-tuning condition is met.

10. The method of claim 1, further comprising:
performing, by the processor, a fallback operation to deactivate the CSI prediction model or reduce a prediction length of the CSI prediction model in an event that a fallback condition is met.

11. An apparatus, comprising:
a transceiver which, during operation, wirelessly communicates with at least one network node; and
a processor communicatively coupled to the transceiver such that, during operation, the processor performs operations comprising:
receiving, via the transceiver, a channel state information-reference signal (CSI-RS) from the network node;
performing a CSI prediction according to a CSI prediction model and the CSI-RS; and
performing a model monitoring on the CSI prediction model to determine whether to adjust the CSI prediction model.

12. The apparatus of claim 11, wherein the processor is further configured to perform operations comprising:
transmitting, via the transceiver, a user equipment (UE) capability to the network node; and
receiving, via the transceiver, a CSI prediction model identification (ID) of the CSI prediction model from the network node.

13. The apparatus of claim 12, wherein the UE capability comprises at least one of a CSI prediction capability, a model fine-tuning capability, and a non-AI-based CSI prediction capability.

14. The apparatus of claim 13, wherein the CSI prediction capability, the model fine-tuning capability, and the non-AI-based CSI prediction capability are respectively indicated by one bit.

15. The apparatus of claim 11, wherein the processor is further configured to perform operations comprising:
triggering the CSI prediction without receiving a CSI prediction model ID from the network node.

16. The apparatus of claim 11, wherein in performing the model monitoring, the processor determines whether a difference between a first normalized mean square error (NMSE) value at a current monitoring time point and a second NMSE value at a previous monitoring time point is larger than a threshold, and determines to switch the CSI prediction model in an event that the difference is larger than the threshold.

17. The apparatus of claim 11, wherein in performing the model monitoring, the processor calculates a time-domain-channel-properties (TDCP) value, and determines whether to switch the CSI prediction model according to the TDCP value.

18. The apparatus of claim 11, wherein in performing the model monitoring, the processor obtains a global navigation satellite system (GNSS) information, and determines whether to switch the CSI prediction model according to a speed associated with the GNSS information.

19. The apparatus of claim 11, wherein the processor is further configured to perform operations comprising:
performing, by the processor, a model fine-tuning operation for the CSI prediction model in an event that a model fine-tuning condition is met.

20. The apparatus of claim 11, wherein the processor is further configured to perform operations comprising:
performing, by the processor, a fallback operation to deactivate the CSI prediction model or reduce a prediction length of the CSI prediction model in an event that a fallback condition is met.
